(19) United States
(12) Patent Application Publication
(10) Pub. No.: US 2022/0206623 A1
(43) Pub. Date: Jun. 30, 2022

(54) DISPLAY DEVICE

(71) Applicant: SHARP KABUSHIKI KAISHA, Sakai City, Osaka (JP)

(72) Inventors: MASAKI YAMANAKA, Sakai City, Osaka (JP); YI SUN, Sakai City, Osaka (JP); TAKAO SAITOH, Sakai City, Osaka (JP); MASAHIKO MIWA, Sakai City, Osaka (JP); YOHSUKE KANZAKI, Sakai City, Osaka (JP)

(21) Appl. No.: 17/603,316

(22) PCT Filed: Apr. 19, 2019
(86) PCT No.: PCT/JP2019/016893

§ 371 Date: Oct. 12, 2021

(51) Int. Cl. G06F 3/041

(52) U.S. Cl. CPC G06F 3/0412; G06F 2203/04112; G06F 3/04164

(57) ABSTRACT

A display device includes: a thin-film transistor layer; a light emitter including a first electrode, a function layer and a second electrode; a sealing layer; and a touch panel layer including a lower electrode and a plurality of upper electrodes. The lower electrode is composed of a plurality of transparent wires. The plurality of upper electrodes are composed of a plurality of upper wires. Each of the plurality of upper electrodes overlaps the lower electrode with an insulating film interposed between each of the plurality of upper electrodes and the lower electrode. Each of the plurality of transparent wires is wider than each of the plurality of upper wires.

### TECHNICAL FIELD

The present invention relates to a display device.

### BACKGROUND ART

Patent Literature 1 discloses a touch panel that includes a sensing electrode and a shield electrode.

### CITATION LIST

### Patent Literature

Patent Literature 1: Japanese Patent Application Laid-Open No. 2014-164327 (published on Sep. 8, 2014)

### SUMMARY OF INVENTION

### Technical Problem

In a touch panel layer, when two adjacent upper electrodes (a first upper electrode and a second upper electrode) overlap a lower electrode with an insulating film interposed therebetween, the insulating film at its stepped portion has residues on the upper layer (metal layer). The residues can establish a short circuit between the two upper electrodes.

### Solution to Problem

A display device according to one aspect of the present invention includes the following: a thin-film transistor layer; a light emitter including a first electrode, a function layer and a second electrode; a sealing layer; and a touch panel layer including a lower electrode and a plurality of upper electrodes. The lower electrode is composed of a plurality of transparent wires. The plurality of upper electrodes are composed of a plurality of upper wires. Each of the plurality of upper electrodes overlaps the lower electrode with an insulating film interposed between each of the plurality of upper electrodes and the lower electrode. Each of the plurality of transparent wires is wider than each of the plurality of upper wires.

### Advantageous Effect of Invention

The aspect of the present invention can avoid a short circuit between the plurality of upper electrodes.

### BRIEF DESCRIPTION OF DRAWINGS

FIG. 1(a) is a schematic plan view of the configuration of a display device according to a first embodiment, and FIG. 1(b) is a sectional view of the configuration of the display device according to the first embodiment.

FIG. 2 illustrates touch panel principles in a sectional view.

FIG. 3(a) is a plan view of the configuration of an upper electrode, and FIGS. 3(b) and (c) illustrate the relationship in a plan view between a lattice wire of the upper electrode and a sub-pixel.

FIG. 4(a) is a plan view of the configuration of a lower electrode, and FIGS. 4(b) and (c) illustrate the relationship in a plan view between a lattice wire of the lower electrode and a sub-pixel.

FIG. 5(a) is a plan view of the configuration of the display device according to the first embodiment, FIG. 5(b) is a sectional view taken along line b-b in FIG. 5(a), and FIG. 5(c) is a sectional view taken along line c-c in FIG. 5(a).

FIG. 6(a) is a plan view of the configuration of a display device according to a comparative example, FIG. 6(b) is a sectional view taken along line b-b in FIG. 6(a), FIG. 6(c) is a sectional view taken along line c-c in FIG. 6(a), FIG. 6(d) is a sectional view taken along line d-d in FIG. 6(a), and FIG. 6(e) is a sectional view taken along line e-e in FIG. 6(a).

FIG. 7 is a plan view of the display device according to the first embodiment.

FIG. 8 illustrates a display device according to a second embodiment.

FIG. 9 illustrates a display device according to a third embodiment.

FIG. 10 illustrates a display device according to a fourth embodiment.

### DESCRIPTION OF EMBODIMENTS

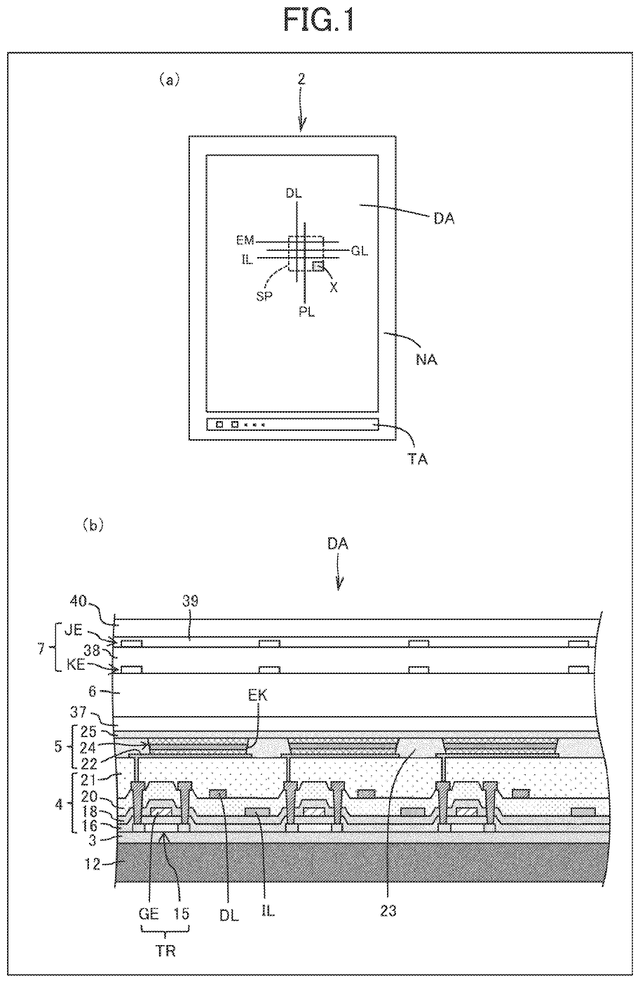

FIG. 1(a) is a schematic plan view of the configuration of a display device according to a first embodiment, and FIG. 1(b) is a sectional view of the configuration of the display device according to the first embodiment. A display device 2 has a base 12 on which a barrier layer 3, a thin-film transistor layer 4, a top-emission light emitter layer 5, an interlayer insulating film 37, a sealing layer 6, a touch panel layer 7, and a function film 40 are disposed in this order. The display device 2 also has a display region DA in which a plurality of sub-pixels SP are disposed. The display region DA is surrounded by a frame section NA, in which a terminal section TA for mounting electronic circuit boards (such as an IC chip and an FPC) is disposed. The touch panel layer 7 may be an on-cell layer disposed on the sealing layer 6 or a layer bonded on the sealing layer 6.

The base 12 may be a glass substrate or a flexible substrate including a resin film of, for instance, polyimide. Two resin films and an inorganic insulating film sandwiched therebetween can also constitute a flexible substrate. The base 12 may have a lower surface on which a film of PET or other materials is attached.

The barrier layer 3 protects the TFT layer 4 and light emitter layer 5 from intrusion of foreign substances, such as water and oxygen. The barrier layer 3 can be a silicon oxide film, a silicon nitride film or a silicon oxide nitride, all formed through CVD, or can be a stack of these films.

As illustrated in FIG. 1(b), the thin-film transistor layer 4 includes the following: a semiconductor layer (including a semiconductor film 15) disposed in a higher position than the barrier layer 3; an inorganic insulating film 16 (gate insulating film) in a higher position than the semiconductor layer; a first metal layer (including gate electrodes GE) in a higher position than the inorganic insulating film 16; an inorganic insulating it t 18 in a higher position than the first metal layer; a second metal layer (including initialization power-source lines IL) in a higher position than the inorganic insulating film 18; an inorganic insulating film 20 in a higher position than the second metal layer; a third metal layer (including data signal lines DL) in a higher position than the inorganic insulating film 20; and a flattening film 21 in a higher position than the third metal layer.

The semiconductor film 15 is made of, for instance, amorphous silicon, low-temperature polysilicon (LTPS) or oxide semiconductor. The semiconductor film 15 together with the gate electrode GE constitutes a thin-film transistor TR. The thin-film transistor TR, although having a bottom-gate structure in the drawing, may be of any structure.

The display region DA is provided with a light emitter X and a pixel circuit, both are provided for each sub-pixel SP, and the thin-film transistor layer 4 includes the pixel circuit and a wire connected to the pixel circuit. Examples of the wire connected to the pixel circuit include a scan signal line GL and an light-emission control line EM, both included in the first metal layer, the initialization power-source line IL, included in the second metal layer, and the data signal line DL and a high-voltage power-source line PL, both included in the third metal layer. The pixel circuit includes the following: a drive transistor that regulates a current flowing through the light emitter X; a write transistor connected to the scan signal line GL; a light-emission control transistor connected to the light-emission control line; and other components.

The first to third metal layers are each a monolayer film of metal including at least one of; for instance, aluminum, tungsten, molybdenum, tantalum, chromium, titanium and copper, or the first to third metal layers are each a multilayer film of these metals.

The inorganic insulating films 16, 18 and 20 each can be a silicon oxide (SiOx) film or a silicon nitride (SiNx) film both formed through CVD, or the inorganic insulating films 16, 18 and 20 each can be a laminated film of these materials. The flattening film 21 can be made of an organic material that can be applied, such as polyimide or acrylic resin.

The light emitter layer 5 includes the following components on the flattening film 21: a first electrode (anode) 22; an edge cover film 23 insulating and covering the edge of the first electrode 22; a function layer 24 disposed in a higher position than the edge cover film 23; and a second electrode cathode)) 25 in a higher position than the function layer 24. The edge cover film 23 is formed by applying an organic material, such as polyimide or acrylic resin, followed by patterning through photolithography.

The light emitter layer 5 includes a plurality of light emitters X that emit a plurality colors of light, and each light emitter includes the first electrode 22, the function layer 24 and the second electrode 25, all provided in the form of an island. The second electrode 25 is a flat common electrode shared among the plurality of light emitters.

Each light emitter X may be an organic light-emitting diode (OLED) including an organic layer as a luminous layer, or the light emitter X may be a quantum-dot light-emitting diode (QLED) including a quantum dot layer as a luminous layer.

The function layer 24 has a stack of, in sequence from the bottom, a hole injection layer, a hole transport layer, a luminous layer EK, an electron transport layer and an electron injection layer for instance. The luminous layer is provided in the form of an island in an opening (for each sub-pixel) of the edge cover film 23 through evaporation, ink jetting or photolithography. The other layers are provided in the form of an island or in a flat manner (i.e., common layer). In some embodiments, one or more of the hole injection layer, hole transport layer, electron transport layer and electron injection layer can be omitted.

The first electrode 22 is composed of a stack of indium tin oxide (ITO) and silver (Ag) or a stack of ITO and Ag-containing alloy for instance. The first electrode 22 reflects light. The second electrode 25 (cathode) is composed of a metal thin film of, for instance, alloy of magnesium and silver. The second electrode 25 transmits light.

When each light emitter X is an OLED, a drive current between the first electrode 22 and second electrode 25 causes holes and electrons to rejoin within the luminous layer EK, thus generating excitons. These excitons emit light in the process of transition to a ground state. When each light emitter X is a QLED, a drive current between the first electrode 22 and second electrode 25 causes holes and electrons to rejoin within the luminous layer EK, thus generating excitons. These excitons emit light in the process of transition from a conduction band level of the quantum dots to a valence band level of the quantum dots.

The interlayer insulating film 37 can be composed of, but not limited to, a silicon nitride film, a silicon oxide film or an organic film.

The sealing layer 6 prevents foreign substances, such as water and oxygen, from penetrating the light emitter layer 5 and can be composed of, for instance, two inorganic sealing films and an organic film sandwiched therebetween.

The touch panel layer 7 includes, in sequence, a lower electrode KE, an insulating film 38, a plurality of upper electrodes SE, and an insulating film 39. Each upper electrode JE is composed of, for instance, a laminated film of titanium and aluminum, a molybdenum monolayer film or a titanium monolayer film. The lower electrode KE is composed of an ITO film or an IZO film for instance. The lower electrode KE has a larger sheet resistance than the upper electrode.

The function film 40 functions as, but not limited to, an optical element and a protector.

### First Embodiment

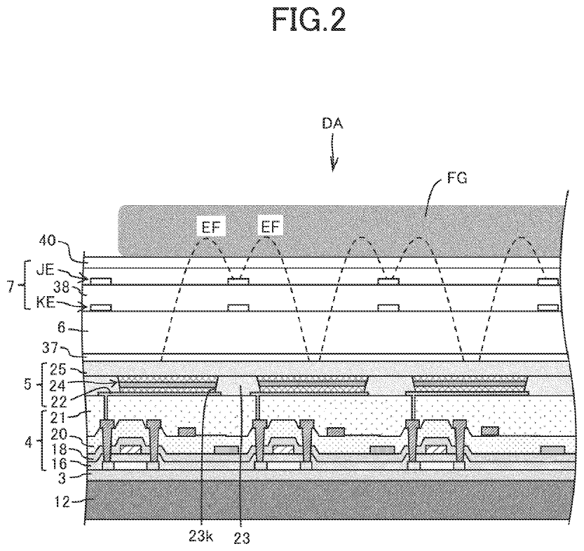

FIG. 2 illustrates touch panel principles in a sectional view. As illustrated in FIG. 2, an electric field EF established between the second electrode 25 and upper electrode JE varies depending on a contact substance FG (e.g., a human finger), and hence periodically obtaining the potential of the plurality of upper electrodes JE in the display region DA can identify a touch location in the display region DA.

In the light emitter layer 5, the edge cover film 23, covering the edge of the first electrode 22, has an opening 23k from which the upper surface of the first electrode 22 is exposed. The plurality of upper electrodes JE do not overlap the opening 23k. This is because that above the opening 23k is a region where the light emitters X emit light, and that the efficiency of light use lowers if the upper electrodes JE, which block light, overlaps the opening 23k.

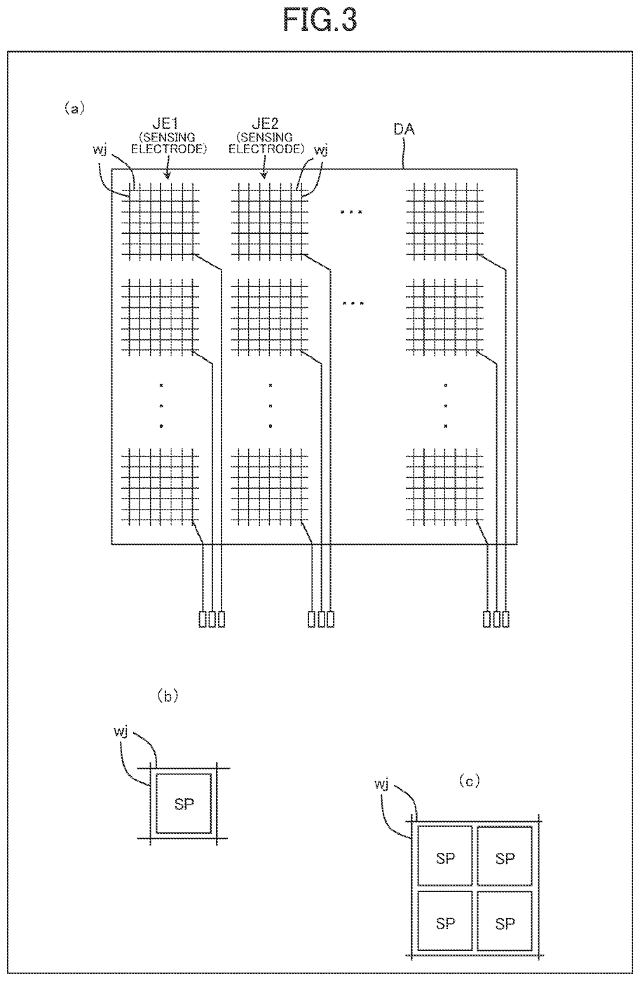

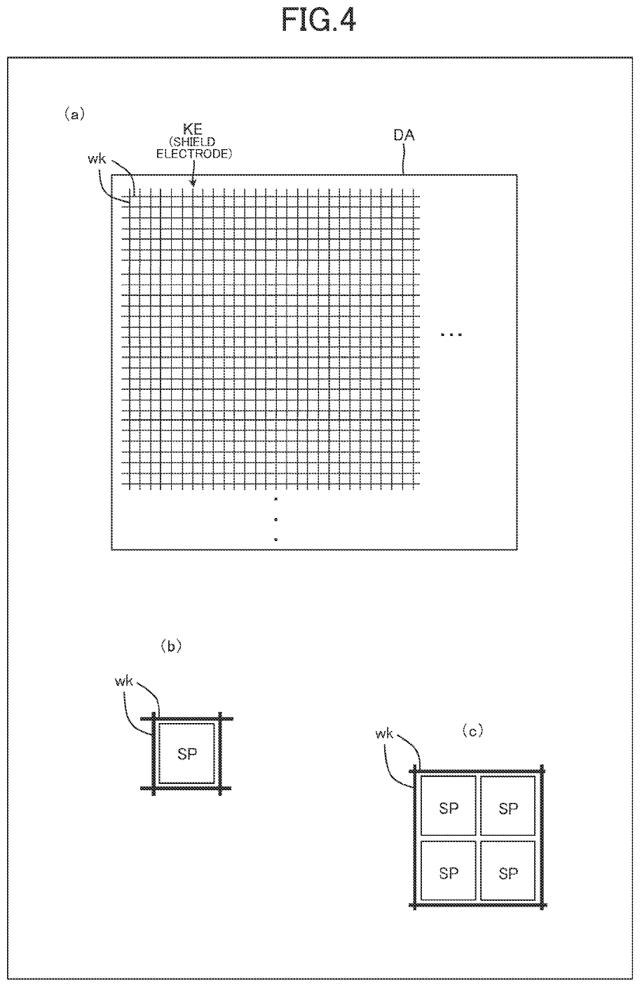

FIG. 3(a) is a plan view of the configuration of the upper electrode, and FIGS. 3(b) and (c) illustrate the relationship in a plan view between a lattice wire of the upper electrode and a sub-pixel. FIG. 4(a) is a plan view of the configuration of the lower electrode, and FIGS. 4(b) and (c) illustrate the relationship in a plan view between a lattice wire of the lower electrode and a sub-pixel.

As illustrated in FIGS. 3 and 4, the touch panel layer 7 in FIGS. 1 and 2 includes the following: a first upper electrode JE1 and a second upper electrode JE2 both functioning as sensing electrodes; and the lower electrode KE overlapping the first upper electrode JE1 and second upper electrode JE2 and functioning as a shield electrode.

As illustrated in FIG. 3(a), the first upper electrode JE1 and the second upper electrode JE2 are adjacent to each other and electrically separated from each other. Each of the first upper electrode JE1 and second upper electrode JE2 is a mesh electrode and is composed of an upper lattice wire wj including a plurality of upper wires of uniform width.

As illustrated in FIG. 4(a), the lower electrode KE is shared between the first upper electrode JE1 and second upper electrode JE2. The lower electrode KE is a mesh electrode overlapping the first upper electrode JE1 and second upper electrode JE2 and is composed of a transparent lattice wire wk including a plurality of transparent wires of uniform width. The transparent lattice wire wk is wider than the upper lattice wire wj.

In the configuration in FIG. 3(b) and FIG. 4(b), the lattice wires wj and wk have their sections each provided with a single sub-pixel SP in a plan view, and each of the first upper electrode JE1 and second upper electrode JE2 is shared among the plurality of sub-pixels SP.

In the configuration in FIG. 3(c) and FIG. 4(c), the lattice wires wj and wk have their sections each provided with a plurality of sub-pixels SP in a plan view, and each of the first upper electrode JE1 and second upper electrode JE2 is shared among the plurality of sub-pixels SP.

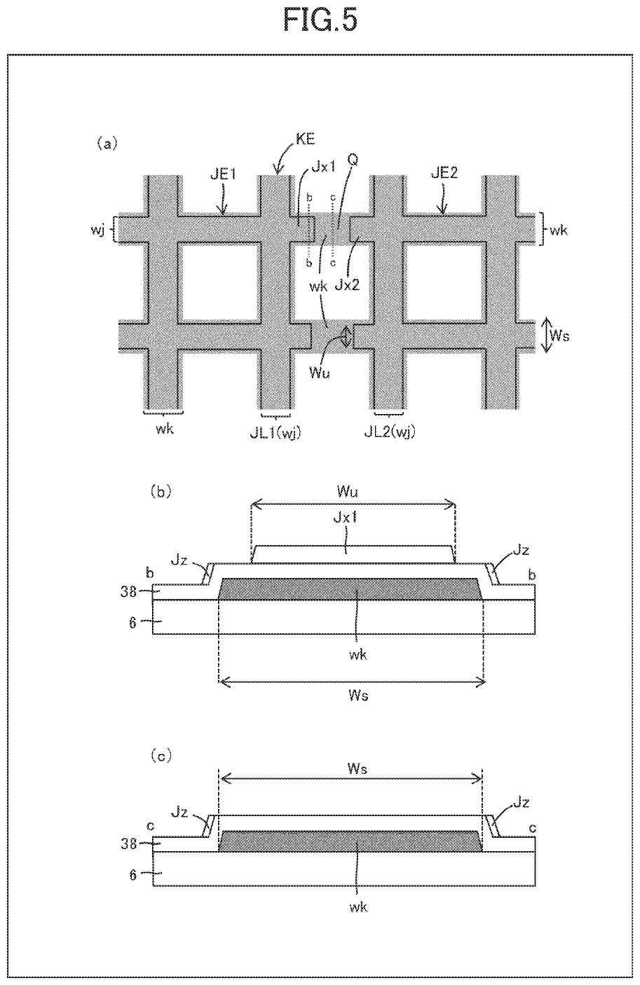

FIG. 5(a) is a plan view of the configuration of the display device according to the first embodiment, FIG. 5(b) is a sectional view taken along line b-b in FIG. 5(a), and FIG. 5(c) is a sectional view taken along line c-c in FIG. 5(a).

As illustrated in FIG. 5, the first upper electrode JE1 has a first protrusion Jx1 protruding toward the second upper electrode JE2, and the second upper electrode JE2 has a second protrusion Jx2 protruding toward the first upper electrode JE1. To be specific, the first wire JL1 of the first upper electrode JE1 and the second wire JL2 of the second upper electrode JE2 extend in the same direction and face each other. The first protrusion Jx1 protrudes from the first wire JLI toward the second wire and the second protrusion Jx2 protrudes from the second wire JL2 toward the first wire JL1. The first protrusion Jx1 and the second protrusion Jx2 face each other with a space Q. The first wire JL1, the second wire JL2, the first protrusion Jx1, and the second protrusion Jx2 are the end of the upper lattice wire wj in FIG. 3, and the first protrusion Jx1 and the second protrusion Jx2 improve sensing accuracy.

The transparent lattice wire wk has a width Ws greater than the width, Wu, of the upper lattice wire wj and overlaps, in a plan view, the entire first protrusion Jx1, the entire second protrusion Jx2, the entire first wire and the entire second wire JL2. Thus, metal residues Jz that remain between the first wire JL1 and second wire JL2 when the first upper electrode JE1 and second upper electrode JE2 are formed are separated from the first protrusion Jx1, second protrusion Jx2, first wire JL1 and first wire ml and are thus never coupled. This can avoid a short circuit in the first upper electrode JE1 and second upper electrode JE2.

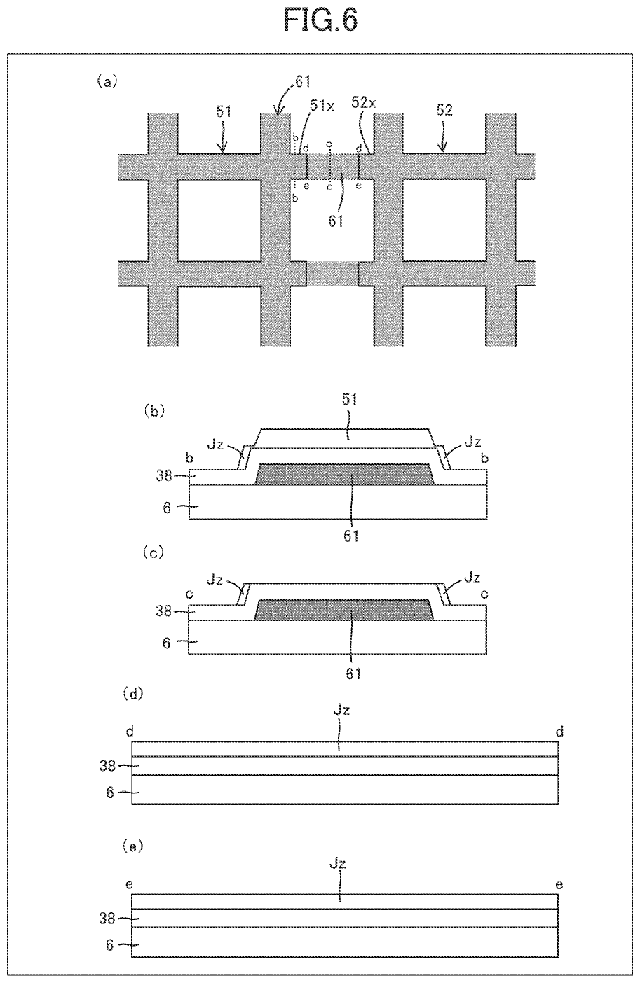

FIG. 6(a) is a plan view of the configuration of a display device according to a comparative example, FIG. 6(b) is a sectional view taken along line b-b in FIG. 6(a), FIG. 6(c) is a sectional view taken along line c-c in FIG. 6(a), FIG. 6(d) is a sectional view taken along line d-d in FIG. 6(a), and FIG. 6(e) is a sectional view taken along line e-e in FIG. 6(a). When a transparent lattice wire and an upper lattice wire have the same width, as illustrated in FIG. 6, metal residues Jz are coupled to a first protrusion 51x and a second protrusion 52x, thus highly possibly producing leak paths (a short-circuit path of a first upper electrode 51 and of a second upper electrode 52).

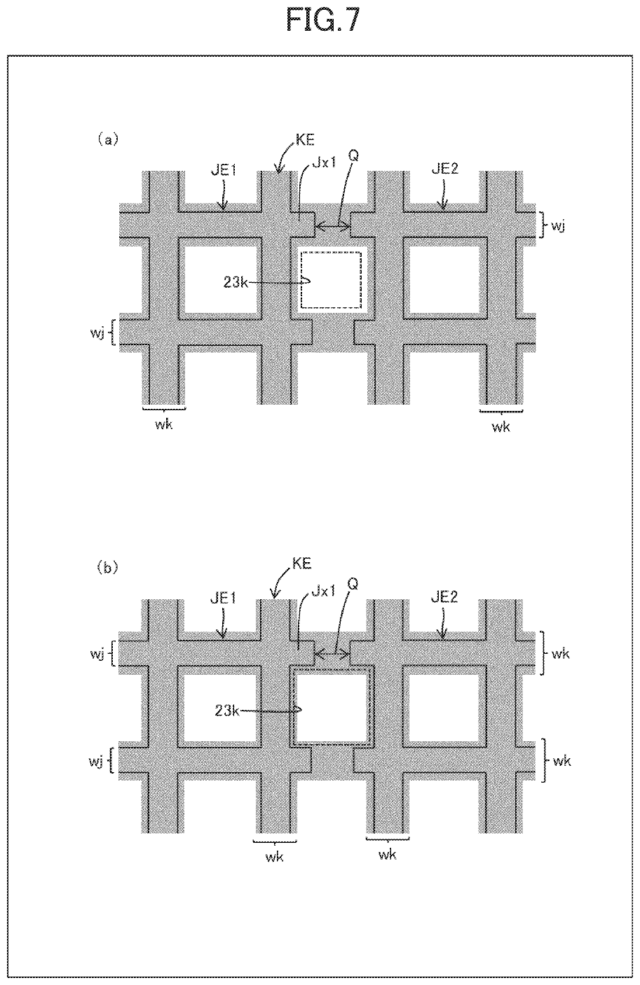

FIG. 7 is a plan view of the display device according to the first embodiment. The first embodiment may include a configuration as illustrated in FIG. 7(a) where each of the upper lattice wire wj and transparent lattice wire wk does not overlap the opening 23k (corresponding to the light emission region of a sub-pixel) of the edge cover film 23. Alternatively, the first embodiment may include a configuration as illustrated in FIG. 7(b) where the upper lattice wire wj does not overlap the opening 23k of the edge cover film 23, whereas the transparent lattice wire wk overlaps the opening 23k of the edge cover film 23. The lower electrode KE, composed of the transparent lattice wire wk, never prevents the exit of light even when the electrode KE overlaps the opening 23k. The lower electrode KE is thus suitable for achieving high definition.

### Second Embodiment

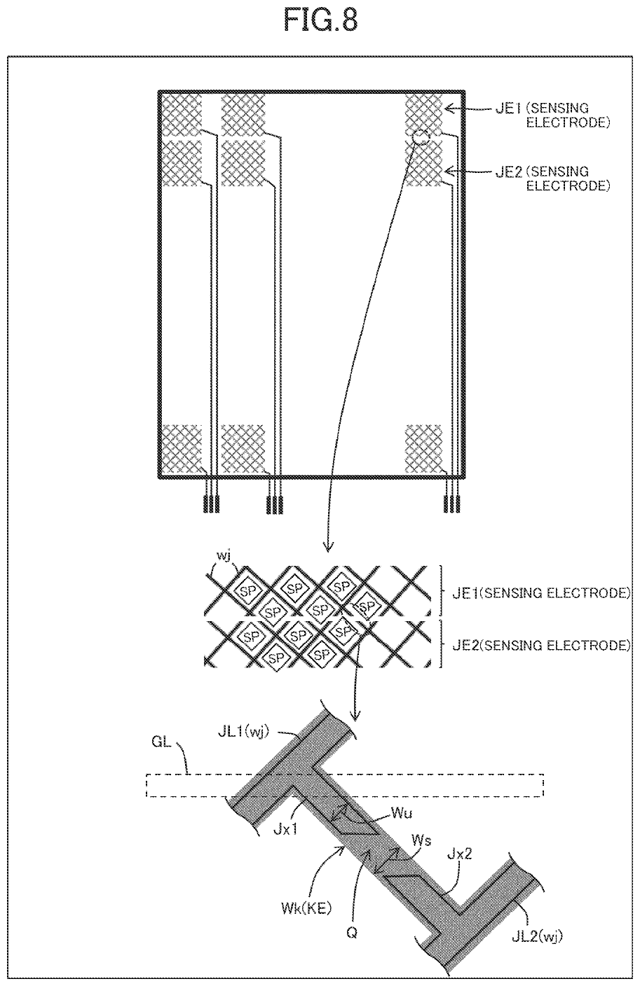

FIG. 8 illustrates a display device according to a second embodiment. The first embodiment has described, by way of example, that the upper lattice wire wj, constituting the first upper electrode JE1 and the second upper wire JE2, is parallel to or orthogonal to the scan signal line GL. In some embodiments, the upper lattice wire wj, constituting the first upper electrode JE1 and the second upper wire JE2, may be oblique (e.g., inclined at 45 degrees and 135 degrees) to the scan signal line GL, as illustrated in FIG. 8. The first upper electrode JE1 and the second upper wire JE2 are both sensing electrodes and are adjacent to each other in a direction parallel to or orthogonal to the scan signal line GL. The lower electrode KE is a shield electrode.

In FIG. 8, the first protrusion Jx1, protruding from the first wire which is the end of the first upper electrode JE1, toward the second upper electrode JE2, and the second protrusion Jx2, protruding from the second wire JL2, which is the end of the second upper electrode JE2, toward the first upper electrode JE1, face each other with a space Q.

The transparent lattice wire wk has a width Ws greater than the width Wu of the upper lattice wire wj and overlaps, in a plan view, the entire first protrusion Jx1, the entire second protrusion Jx2, the entire first wire JL1 and the entire second wire JL2. Thus, metal residues that remain between the first wire JL1 and second wire JL2 when the first upper electrode JE1 and second upper electrode JE2 are formed are separated from the first protrusion Jx1, second protrusion Jx2, first wire JL1 and first wire JL1 and are thus never coupled. This can avoid a short circuit between the first upper electrode JE1 and second upper electrode JE2, both of which are sensing electrodes.

### Third Embodiment

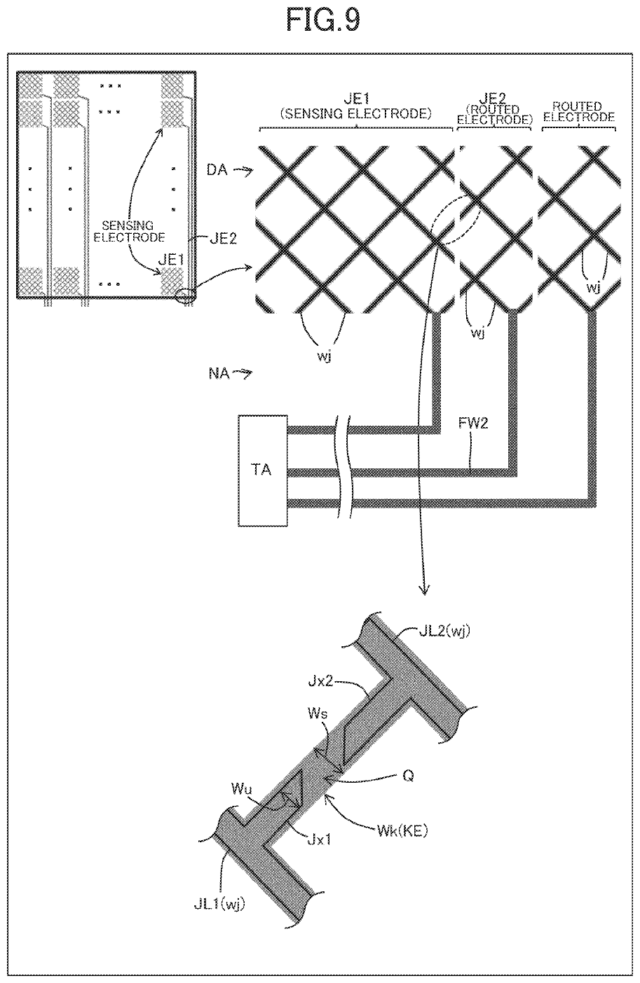

FIG. 9 illustrates a display device according to a third embodiment. The first and second embodiments have described, by way of example, that the first upper electrode JE1 and the second upper wire JE2 are sensing electrodes. In some embodiments, the first upper electrode JE1 may be a sensing electrode, the second upper electrode JE2 may be a routed electrode, and the lower electrode KE may be a shield electrode, as illustrated in FIG. 9. The second upper electrode JE2 is a mesh electrode and is composed of the upper lattice wire wj in the display region DA. The second upper electrode JE2, a routed electrode, has one end connected to the sensing electrode and the other end connected to the terminal section TA disposed in the thin-film transistor 4, via a routed wire FW2 disposed in the frame region NA.

In FIG. 9, the first protrusion Jx1, protruding from the first wire JL1, which is the end of the first upper electrode JE1, toward the second upper electrode JE2, and the second protrusion Jx2, protruding from the second wire JL2, which is the end of the second upper electrode JE2, toward the first upper electrode JE1, face each other with a space Q.

The transparent lattice wire wk has a width Ws greater than the width Wu of the upper lattice wire wj and overlaps, in a plan view, the entire first protrusion Jx1, the entire second protrusion Jx2, the entire first wire JL1 and the entire second wire JL2. Thus, metal residues that remain between the first wire JL1 and second wire JL2 when the first upper electrode JE1 and second upper electrode JE2 are formed are separated from the first protrusion Jx1, second protrusion Jx2, first wire JL1 and first wire JL1 and are thus never coupled. This can avoid a short circuit between the first upper electrode JE1, which is a sensing electrode, and the second upper electrode JE2, which is a routed electrode.

### Fourth Embodiment

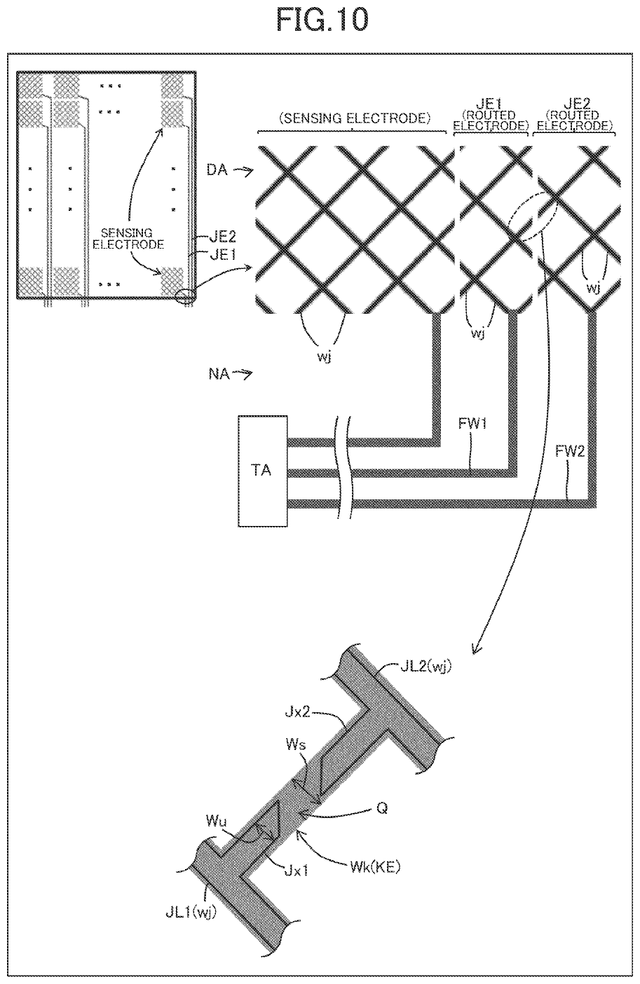

FIG. 10 illustrates a display device according to a fourth embodiment. In FIG. 10, the first upper electrode JE1 and the second upper electrode JE2 are both routed electrodes, and the lower electrode KE is a shield electrode. The first upper electrode JE1 and the second upper electrode JE2 are both mesh electrodes and are composed of the upper lattice wire wj in the display region DA. The first upper electrode JE1, a routed electrode, has one end connected to a sensing electrode and the other end connected to the terminal section TA via a routed wire FW1 disposed in the frame region NA. The second upper electrode JE2, a routed electrode, has one end connected to the sensing electrode and the other end connected to the terminal section TA via the routed wire FW2 disposed in the frame region NA.

The transparent lattice wire wk has a width Ws greater than the width Wu of the upper lattice wire wj and overlaps, in a plan view, the entire first protrusion Jx1, the entire second protrusion Jx2, the entire first wire JL1 and the entire second wire JL2. Thus, metal residues that remain between the first wire JL1 and second wire JL2 when the first upper electrode JE1 and second upper electrode JE2 are formed are separated from the first protrusion Jx1, second protrusion Jx2, first wire JE1 and second wire JL2 and are thus never coupled. This can avoid a short circuit between the first upper electrode JE1 and second upper electrode JE2, both of which are routed electrodes.

The foregoing embodiments are illustrative and descriptive and are thus not restrictive. One of ordinary skill in the art obviously understands that numerous modifications can be devised based on these illustrative and descriptive embodiments.

Summary

First Aspect

A display device includes the following: a thin-film transistor layer; a light emitter including a first electrode, a function layer and a second electrode; a sealing layer; and a touch panel layer including a lower electrode and a plurality of upper electrodes. The lower electrode is composed of a plurality of transparent wires. The plurality of upper electrodes are composed of a plurality of upper wires. Each of the plurality of upper electrodes overlaps the lower electrode with an insulating film interposed between each of the plurality of upper electrodes and the lower electrode. Each of the plurality of transparent wires is wider than each of the plurality of upper wires.

Second Aspect

In the display device according to the first aspect for instance, the lower electrode is shared among the plurality of upper electrodes electrically separated from each other.

Third Aspect

In the display device according to the first or second aspect for instance, the plurality of upper wires constitute an upper lattice wire, and the plurality of transparent wires constitute a transparent lattice wire overlapping the upper lattice wire.

Fourth Aspect

In the display device according to the third aspect for instance, the transparent lattice wire has one section corresponding to one sub-pixel.

Fifth Aspect

The display device according to any one of, for instance, the first to fourth aspects includes an edge cover film covering the edge of the first electrode. The edge cover film has an opening from which the upper surface of the first electrode is exposed. Each of the plurality of upper electrodes does not overlap the opening.

Sixth Aspect

In the display device according to any one of the first to fifth aspects for instance, each of the plurality of upper electrodes is shared among a plurality of sub-pixels.

Seventh Aspect

In the display device according to the fifth aspect for instance, each of the plurality of transparent wires has an end overlapping the opening.

Eighth Aspect

In the display device according to any one of the first to seventh aspects for instance, the lower electrode has a larger sheet resistance than each of the plurality of upper electrodes.

Ninth Aspect

In the display device according to any one of the first to eighth aspects for instance, the plurality of upper wires include first and second wires extending in an identical direction and facing each other, the first wire has a first protrusion protruding toward the second wire, and the second wire has a second protrusion protruding toward the first wire.

Tenth Aspect

In the display device according to any one of the first to ninth aspects for instance, the lower electrode functions as a shield electrode in the touch panel layer.

Eleventh Aspect

In the display device according to the tenth aspect for instance, the plurality of upper electrodes include a first upper electrode and a second upper electrode adjacent to each other and each functioning as a sensing electrode.

Twelfth Aspect

In the display device according to any one of the first to eleventh aspects for instance, each of the plurality of upper wires contains at least one of titanium, aluminum and molybdenum, and each of the plurality of transparent wires contains 1TO or IZO.

Thirteenth Aspect

The display device according to, for instance, the tenth aspect includes the following: a terminal section disposed in a frame region surrounding a display region; and a plurality of sensing electrodes connected to the terminal section via a plurality of routed electrodes. The plurality of upper electrodes include a first upper electrode and a second upper electrode adjacent to each other. One of the first and second upper electrodes functions as a sensing electrode, and the other of the first and second upper electrodes functions as a routed electrode.

Fourteenth Aspect

The display device according to, for instance, the tenth aspect includes the following: a terminal section disposed in a frame region surrounding a display region; and a plurality of sensing electrodes connected to the terminal section via a plurality of routed electrodes. The plurality of upper electrodes include a first upper electrode and a second upper electrode adjacent to each other and each functioning as a routed electrode.

Fifteenth Aspect

In the display device according to any one of the first to fourteenth aspects for instance, each of the plurality of upper wires entirely overlaps any of the plurality of transparent wires in a plan view.

### REFERENCE SIGNS LIST

3 barrier layer

4 thin-film transistor layer

5 light emitter layer

6 sealing layer

7 touch panel layer

12 base

21 flattening film

23 edge cover film

24 function layer

TA terminal section

JE1 first upper electrode

Jx1 first protrusion

JE2 second upper electrode

Jx2 second protrusion

Jz metal residue

KE lower electrode

Q space

upper lattice wire wj

transparent lattice wire wk

first wire JL1

second wire JL2

What is claimed is:

1. A display device comprising:
a thin-film transistor layer;
a light emitter including a first electrode, a function layer and a second electrode;
a sealing layer; and
a touch panel layer including a lower electrode and a plurality of upper electrodes,
wherein the lower electrode is composed of a plurality of transparent wires,
the plurality of upper electrodes are composed of a plurality of upper wires,
each of the plurality of upper electrodes overlaps the lower electrode with an insulating film interposed between each of the plurality of upper electrodes and the lower electrode, and
each of the plurality of transparent wires is wider than each of the plurality of upper wires.

2. The display device according to claim 1, wherein p1 the lower electrode is shared among the plurality of upper electrodes electrically separated from each other.

3. The display device according to claim 1, wherein
the plurality of upper wires constitute an upper lattice wire, and
the plurality of transparent wires constitute a transparent lattice wire overlapping the upper lattice wire.

4. The display device according to claim 3, wherein
the transparent lattice wire has one section corresponding to one sub-pixel.

5. The display device according to claim 1, to comprising
an edge cover film covering an edge of the first electrode,
wherein the edge cover film has an opening from which an upper surface of the first electrode is exposed, and
each of the plurality of upper electrodes does not overlap the opening.

6. The display device according to claim 1, wherein
each of the plurality of upper electrodes is shared among a plurality of sub-pixels.

7. The display device according to claim 5, wherein
each of the plurality of transparent wires has an end overlapping the opening.

8. The display device according to claim 1, wherein
the lower electrode has a larger sheet resistance than each of the plurality of upper electrodes.

9. The display device according to claim 1, wherein
the plurality of upper wires include first and second wires extending in an identical direction and facing each other,
the first wire has a first protrusion protruding toward the second wire, and
the second wire has a second protrusion protruding toward the first wire.

10. The display device according to claim 1, wherein
the lower electrode functions as a shield electrode in the touch panel layer.

11. The display device according to claim 10, wherein
the plurality of upper electrodes include a first upper electrode and a second upper electrode adjacent to each other and each functioning as a sensing electrode.

12. The display device according to claim 1, wherein
each of the plurality of upper wires contains at least one of titanium, aluminum and molybdenum, and
each of the plurality of transparent wires contains ITO or IZO.

13. The display device according to claim 10, comprising:
a terminal section disposed in a frame region surrounding a display region; and
a plurality of sensing electrodes connected to the terminal section via a plurality of routed electrodes,
wherein the plurality of upper electrodes include a first upper electrode and a second upper electrode adjacent to each other, one of the first and second upper electrodes functioning as a sensing electrode and another one of the first and second upper electrodes functioning as a routed electrode.

14. The display device according to claim 10, comprising:
a terminal section disposed in a frame region surrounding a display region; and
a plurality of sensing electrodes connected to the terminal section via a plurality of routed electrodes,
wherein the plurality of upper electrodes include a first upper electrode and a second upper electrode adjacent to each other and each functioning as a routed electrode.

15. The display device according to claim 1, wherein
each of the plurality of upper wires entirely overlaps any of the plurality of transparent wires in a plan view.
